(19) United States
(12) Patent Application Publication
(10) Pub. No.: US 2007/0042903 A1
(43) Pub. Date: Feb. 22, 2007

(54) Lanthanum doping catalyst for preparing carbon nanotubes having uniform diameter and producing method thereof

(76) Inventors: Dehuan Huang, Mountain View, CA (US); Xinhua Shi, Ningbo (CN); Fanzhi Kong, Ningbo (CN); Jianshe Ding, Ningbo (CN); Zehua Zhou, Ningbo (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/206,061

(22) Filed: Aug. 18, 2005

(51) Int. Cl. B01J 23/10

(52) U.S. Cl. 502/303

(57) ABSTRACT

Disclosed is a lanthanum doping catalyst for preparing carbon nanotubes having uniform diameter and producing method thereof. The catalyst comprises magnesium oxide as a support, two or three metal oxides selected from the group consisting of ferric oxide, cobalt oxide, and nickel oxide as a complex metal oxide composite, lanthanum oxide as a lanthanum doping composite, and molybdenum oxide as an enhanced catalytic composite. The catalyst is produced by dissolving magnesium salt into distilled water, and into the solution is added metal salt for forming complex metal oxide composite, lanthanum salt for forming lanthanum doping composite and salt for forming enhanced catalytic composite in a molar ratio of 0.5-3.0:0.1-1.0:0.01-1.0:0.5-3.0. The solution is dissolved completely and dried at 120-200° C. for 3-5 hours. Then, the product is calcinated at 550-850° C. for 10-30 minutes and grind to be a fine powder. The catalyst has advantages including higher catalytic efficiency, uniform diameter and good gaphitization of the carbon nanotube product. The producing method for the catalyst is well reproducible, simple, and easily operated.

### BACKGROUND OF THE INVENTION

1. Field of the Invention

The present invention relates to a catalyst for preparing carbon nanotubes, and especially to a lanthanum doping catalysts for preparing carbon nanotubes having uniform diameter and producing method thereof.

2. The Prior Arts

Carbon nanotube is a novel carbon structure found in 1990s of the twentieth century. It draws a great attention because of the excellent properties of mechanics, dynamics, electrics, optics, thermotics and capacity for energy storage, and having a potential to be widely applied in the fields of electronics, chemistry, micromachine and energy. By taking advantage of the superior mechanical, dynamical, and electrical properties, carbon nanotube can be added into various metal, nonmetal or polymeric materials to enhance the material properties and increase the conductivity. By taking advantage of the superior electronic emission property, field emission plane display with low driving voltage is achievable. By taking advantage of the nano-scale size and conductivity, it can be apply to MEMS (micro-electro-mechanical systems) design. By taking advantage of the unique hollow structure as a reactor, we can study the behaviors of many materials in nano-scale. Moreover, by taking advantage of the high surface area of the hollow structure, carbon nanotube can be an electrode material of a nickel metal hydride battery, lithium ion battery or fuel cell.

Currently, methods including arc discharge, laser ablation, and catalytic chemical vapor deposition (CCVD) are generally used to prepare carbon nanotubes. Other methods, such as electrolysis in molten salts, solar energy method, wet chemical method, are also used. Arc discharge is generally used to prepare single-walled carbon nanotubes, and the reaction temperature is over 3000° C. Laser ablation uses high temperature from laser to evaporate the carbon molecules in graphite to rearrange, the required experimental conditions are more critical. Catalytic decomposition of carbon containing gas is the most common method for preparing carbon nanotubes, and the method is advantageous for the simple apparatus, simple operative process, and is especially applicable to large-scale production. However, a key point for using CCVD to prepare carbon nanotubes is the preparation technique for catalyst. Carbon nanotubes with different morphologies and different properties can be prepared using different catalysts. There exists a problem of carbon nanotube uniformity because the properties of carbon nanotube are greatly influenced by the carbon nanotube diameter.

### SUMMARY OF THE INVENTION

To overcome the problem of the conventional techniques, the object of the present invention is to provide a lanthanum doping complex metal oxide catalyst for preparing carbon nanotubes having uniform diameter and producing method thereof. A high productivity of carbon nanotubes with uniform diameter can be achievable by using the catalyst.

A lanthanum doping catalyst for preparing carbon nanotubes having uniform diameter comprises a magnesium oxide support which carries a complex metal oxide composite, a lanthanum doping composite, an enhanced catalytic composite, and the molar ratio of the support, complex metal oxide composite, lanthanum doping composite, and enhanced catalytic composite is 0.5-3.0:0.1-1.0:0.01-1.0:0.5-3.0, wherein, the complex metal oxide composite is a complex of two or three metal oxides selected from the group consisting of ferric oxide, cobalt oxide, and nickel oxide, the lanthanum doping composite comprises lanthanum oxide, and the enhanced catalytic composite comprises molybdenum oxide.

On condition that the complex metal oxide composite comprising two metal oxides, a molar ratio of iron:cobalt, cobalt:nickel or iron:nickel may be 0.1-1.0:0.1:1.0, 0.1-1.0:0.1-1.0, 0.1-1.0:0.1-1.0, respectively. On condition that the complex metal oxide composite comprising three metal oxides, a molar ratio of iron:cobalt:nickel is 0.1-1.0:0.1-1.0:0.1-1.0.

A method for producing a lanthanum doping catalyst for preparing carbon nanotubes having uniform diameter comprises the following steps:

Dissolving magnesium salt into distilled water with stirring to be a solution; adding metal salt for forming complex metal oxide composite, lanthanum salt for forming lanthanum doping composite and molybdenum salt for forming enhanced catalytic composite into the solution with continuous stirring to dissolve completely, and a molar ratio of magnesium salt, metal salts for forming complex metal oxide composite, lanthanum salt for forming lanthanum doping composite and molybdenum salt for forming enhanced catalytic composite is 0.5-3.0:0.1-1.0:0.01-1.0:0.5-3.0; drying the solution at 120-200° C. for 3-5 hours; calcinating at a high temperature of 550-850° C. for 10-30 minutes under aerobic environment; and obtaining the catalyst for preparing carbon nanotubes after grinding the product step to be a fine powder after the step of calcination.

The aforementioned magnesium salt is selected from the group consisting of magnesium nitrate, magnesium chloride, magnesium sulfate, and magnesium acetate, or a mixture of two, three, or four of those magnesium salts.

The metal salt for forming the complex metal oxide composite comprises two or three metal salts selected from the group consisting of iron salt, cobalt salt and nickel salt.

The iron salt is selected from the group consisting of ferric nitrate, ferric chloride, ferric sulfate and ferric acetate. The cobalt salt is selected from the group consisting of cobalt nitrate, cobalt chloride, cobalt sulfate and cobalt acetate. The nickel salt is selected from the group consisting of nickel nitrate, nickel chloride, nickel sulfate and nickel acetate.

In the complex composite comprising iron salt and cobalt salt, a molar ratio of iron:cobalt is 0.1-1.0:0.1-1.0. In the complex composite comprising cobalt salt and nickel salt, a molar ratio of cobalt:nickel is 0.1-1.0:0.1-1.0. In the complex composite comprising iron salt and nickel salt, a molar ratio of iron:nickel is 0.1-1.0:0.1-1.0. In the complex composite comprising iron salt, cobalt salt and nickel salt, a molar ratio of iron:cobalt:nickel is 0.1-1.0:0.1-1.0:0.1-1.0.

The lanthanum salt for forming lanthanum doping composite is selected from the group consisting of lanthanum nitrate, lanthanum carbonate, and lanthanum acetate.

The molybdenum salt for forming enhanced catalytic composite is ammonium molybdate or molybdenum acetate.

A typical process for preparing carbon nanotubes using the catalyst of the present invention is described as follows. The catalyst is put into a reactive chamber, and the gas as carbon source such as methane, aromatice, natural gas, or a mixture of those gases is introduced into the chamber at a flow rate of 500-5000 sccm. The reaction is performed at 750-1000° C. for 20-60 minutes in the chamber filled hydrogen with a flow rate of 0-2000 sccm, nitrogen, or an inert gas with a flow rate of 0-500 sccm to obtain product of multi-walled carbon nanotubes. Moreover, nitrogen or other inert gas can be used to exclude the air in the reactive chamber before growth of carbon nanotubes, and nitrogen or other inert gas can be used to protect the product after growth of carbon nanotubes is completed.

Comparing to the conventional technique, the catalyst of the present invention has a higher catalytic efficiency. In general, weight ratio of the final product (containing catalyst) and catalyst is more than 35, and purity of the carbon nanotubes is more than 90%. Diameter of the carbon nanotubes obtained is uniform and in a range of 10-20 nm. The method for producing the catalyst of the present invention has advantages of good reproducibility, simple process and easy operation.

### BRIEF DESCRIPTION OF THE DRAWINGS

FIG. 1 shows a TEM (transmission electron microscope) micrograph of multi-walled carbon nanotubes produced using the catalyst prepared according to Example 1 of the present invention.

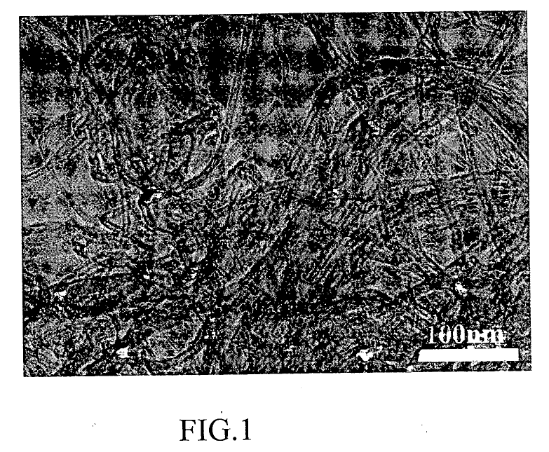

### DETAILED DESCRIPTION OF THE PREFERRED EMBODIMENT

Further objects and advantages of the invention can be more fully understood from the following detailed description taken in conjunction with the accompanying drawings.

### Example 1

A lanthanum doping catalyst for preparing carbon nanotubes having uniform diameter comprises a magnesium oxide support, which carries a complex metal oxide comprising nickel oxide and cobalt oxide, a lanthanum oxide, and a molybdenum oxide. The molar ratio of the support, complex metal oxide, lanthanum oxide, and molybdenum oxide is 105:10:5:120. The molar ratio of nickel and cobalt is 6:4 in the complex metal oxide comprising nickel oxide and cobalt oxide. The molar ratio of nickel and iron is 0.1:1.0 in the complex metal oxide comprising nickel oxide and ferric oxide. The molar ratio of iron and cobalt is 1.0:0.1 in the complex metal oxide comprising cobalt oxide and ferric oxide. And the molar ratio of iron, cobalt, and iron is 0.1:0.5:1.0 in the complex metal oxide comprising ferric oxide, cobalt oxide and nickel oxide.

### Example 2

A lanthanum doping catalyst for preparing carbon nanotubes having uniform diameter comprises a magnesium oxide support, which carries a complex metal oxide comprising nickel oxide and cobalt oxide, a lanthanum oxide, and a molybdenum oxide. The molar ratio of support, complex metal oxide, lanthanum oxide, and molybdenum oxide is 10:1:0.25:12.5. The molar ratio of nickel and cobalt is 5:5 in the complex metal oxide comprising nickel oxide and cobalt oxide. The molar ratio of nickel and iron is 1.0:0.5 in the complex metal oxide comprising nickel oxide and ferric oxide. The molar ratio of iron and cobalt is 1.0:0.8 in the complex metal oxide comprising ferric oxide and cobalt oxide. And the molar ratio of iron, cobalt, and nickel is 0.4:0.6:1.0 in the complex metal oxide comprising ferric oxide, cobalt oxide and nickel oxide.

### Example 3

A lanthanum doping catalyst for preparing carbon nanotubes having uniform diameter comprises a magnesium oxide support, which carries a complex metal oxide comprising nickel oxide and cobalt oxide, a lanthanum oxide, and a molybdenum oxide. The molar ratio of support, complex metal oxide, lanthanum oxide, and molybdenum oxide is 15:1:0.1:8. The molar ratio of nickel and cobalt is 4:1 in the complex metal oxide comprising nickel oxide and cobalt oxide. The molar ratio of nickel and iron is 0.5:0.5 in the complex metal oxide comprising nickel oxide and ferric oxide. The molar ratio of iron and cobalt is 0.1:1.0 in the complex metal oxide comprising ferric oxide and cobalt oxide. And the molar ratio of iron, cobalt, and nickel is 0.1:1.0:0.1 in the complex metal oxide comprising ferric oxide, cobalt oxide and nickel oxide.

### Example 4

A lanthanum doping catalyst for preparing carbon nanotubes having uniform diameter comprises a magnesium oxide support, which carries a complex metal oxide comprising nickel oxide and cobalt oxide, a lanthanum oxide, and a molybdenum oxide. The molar ratio of support, complex metal oxide, lanthanum oxide, and molybdenum oxide is 20:1:1:10. The molar ratio of nickel and cobalt is 9:1 in the complex metal oxide comprising nickel oxide and cobalt oxide. The molar ratio of nickel and iron is 7:3 in the complex metal oxide comprising nickel oxide and ferric oxide. The molar ratio of iron and cobalt is 5:5 in the complex metal oxide comprising cobalt oxide and ferric oxide. And the molar ratio of iron, cobalt, and iron is 1.0:1.0:1.0 in the complex metal oxide comprising ferric oxide, cobalt oxide and nickel oxide.

### Example 5

To produce the lanthanum doping catalyst for preparing carbon nanotubes having uniform diameter, ferric nitrate, cobalt nitrate, lanthanum nitrate, ammonium molybdate and magnesium nitrate are weighted, and the molar ratio of Fe:Co:La:Mo:Mg is 1:10:1:330:155. Firstly, magnesium nitrate is dissolved into an adequate amount of distilled water. Next, ferric nitrate, cobalt nitrate, lanthanum nitrate, and ammonium molybdate are sequentially added into the magnesium nitrate solution. The final solution is dried at 180° C. for three hours after the solution is dissolved completely. The product obtained is calcinated at 700° C. for 30 minutes, and ground to fine powders, and the catalyst obtained is to prepare the carbon nanotubes.

### Example 6

To produce the lanthanum doping catalyst for preparing carbon nanotubes, having uniform diameter, ferric sulfate, cobalt sulfate, lanthanum acetate, ammonium molybdate and magnesium sulfate are weighted, and the molar ratio of Fe:Co:La:Mo:Mg is 10:1:10:55:175. Firstly, magnesium sulfate is dissolved into an adequate amount of distilled water. Next, ferric sulfate, cobalt sulfate, lanthanum acetate and ammonium molybdate are sequentially added into the magnesium sulfate solution. The final solution is dried at 140° C. for five hours after the solution is dissolved completely. The product obtained is calcinated at 750° C. for 20 minutes, and ground to fine powders, and the catalyst obtained is to prepare the carbon nanotubes.

### Example 7

To produce the lanthanum doping catalyst for preparing carbon nanotubes having uniform diameter, ferric chloride, nickel chloride, lanthanum carbonate, ammonium molybdate and magnesium chloride are weighted, and the molar ratio of Fe:Ni:La:Mo:Mg is 1:10:7:230:275. Firstly, magnesium chloride is dissolved into an adequate amount of distilled water. Next, ferric chloride, nickel chloride, lanthanum carbonate and ammonium molybdate are sequentially added into the magnesium chloride solution. The final solution is dried at 150° C. for three hours after the solution is dissolved completely. The product obtained is calcinated at 600° C. for 30 minutes, and ground to fine powders, and the catalyst obtained is to prepare the carbon nanotubes.

### Example 8

To produce the lanthanum doping catalyst for preparing carbon nanotubes having uniform diameter, nickel acetate, cobalt acetate, lanthanum carbonate, ammonium molybdate and magnesium acetate are weighted, and the molar ratio of Ni:Co:La:Mo:Mg is 1:10:4:55:55. Firstly, magnesium acetate is dissolved into an adequate amount of distilled water. Next, nickel acetate, cobalt acetate, lanthanum carbonate and ammonium molybdate are sequentially added into the magnesium acetate solution. The final solution is dried at 160° C. for four hours after the solution is dissolved completely. The product obtained is calcinated at 650° C. for 10 minutes, and ground to fine powders, and the catalyst obtained is to prepare the carbon nanotubes.

### Example 9

To produce the lanthanum doping catalyst for preparing carbon nanotubes having uniform diameter, ferric nitrate, nickel nitrate, lanthanum carbonate, ammonium molybdate and magnesium nitrate are weighted, and the molar ratio of Fe:Ni:La:Mo:Mg is 10:1:8:250:150. Firstly, magnesium nitrate is dissolved into an adequate amount of distilled water. Next, ferric nitrate, nickel nitrate, lanthanum carbonate and ammonium molybdate are sequentially added into the magnesium nitrate solution. The final solution is dried at 140° C. for four hours after the solution is dissolved completely. The product obtained is calcinated at 550° C. for 30 minutes, and ground to fine powders, and the catalyst obtained is to prepare the carbon nanotubes.

### Example 10

To produce the lanthanum doping catalyst for preparing carbon nanotubes having uniform diameter, nickel sulfate, cobalt sulfate, lanthanum nitrate, ammonium molybdate and magnesium nitrate are weighted, and the molar ratio of Ni:Co:La:Mo:Mg is 10:1:1:100:275. Firstly, magnesium nitrate is dissolved into an adequate amount of distilled water. Next, nickel sulfate, cobalt sulfate, lanthanum nitrate and ammonium molybdate are sequentially added into the magnesium nitrate solution. The final solution is dried at 170° C. for three hours after the solution is dissolved completely. The product obtained is calcinated at 700° C. for 20 minutes, and ground to fine powders, and the catalyst obtained is to prepare the carbon nanotubes.

### Example 11

To produce the lanthanum doping catalyst for preparing carbon nanotubes having uniform diameter, ferric chloride, cobalt chloride, nickel chloride, lanthanum acetate, ammonium molybdate and magnesium chloride are weighted, and the molar ratio of Fe:Co:Ni:La:Mo:Mg is 4:5:1:8:160:200. Firstly, magnesium chloride is dissolved into an adequate amount of distilled water. Next, ferric chloride, cobalt chloride, nickel chloride, lanthanum acetate and ammonium molybdate are sequentially added into the magnesium chloride solution. The final solution is dried at 150° C. for three hours after the solution is dissolved completely. The product obtained is calcinated at 600° C. for 30 minutes, and ground to fine powders, and the catalyst obtained is to prepare the carbon nanotubes.

### Example 12

To produce the lanthanum doping catalyst for preparing carbon nanotubes having uniform diameter, nickel nitrate, ferric nitrate, cobalt nitrate, lanthanum nitrate, ammonium molybdate and magnesium nitrate are weighted, and the molar ratio of Ni:Fe:Co:La:Mo:Mg is 1:1:10:1:360:60. Firstly, magnesium nitrate is dissolved into an adequate amount of distilled water. Next, nickel nitrate, ferric nitrate, cobalt nitrate, lanthanum nitrate and ammonium molybdate are sequentially added into the magnesium nitrate solution. The final solution is dried at 180° C. for three hours after the solution is dissolved completely. The product obtained is calcinated at 750° C. for 10 minutes, and ground to fine powders, and the catalyst obtained is to prepare the carbon nanotubes.

### Example 13

To produce the lanthanum doping catalyst for preparing carbon nanotubes having uniform diameter, ferric sulfate, cobalt sulfate, nickel sulfate, lanthanum acetate, ammonium molybdate, magnesium nitrate are weighted, and the molar ratio of Fe:Co:Ni:La:Mo:Mg is 1:10:1:12:170:275. Firstly, magnesium nitrate is dissolved into an adequate amount of distilled water. Next, ferric sulfate, cobalt sulfate, nickel sulfate, lanthanum acetate and ammonium molybdate are sequentially added into the magnesium nitrate solution. The final solution is dried at 150° C. for four hours after the solution is dissolved completely. The product obtained is calcinated at 600° C. for 20 minutes, and ground to fine powders, and the catalyst obtained is to prepare the carbon nanotubes.

What is claimed is:

1. A lanthanum doping catalyst for preparing carbon nanotubes having uniform diameter, comprising:
a magnesium oxide support which carries a complex metal oxide composite, a lanthanum doping composite, and an enhanced catalytic composite, and the molar ratio of support, complex metal oxide composite, lanthanum doping composite, and enhanced catalytic composite being 0.5-3.0:0.1-1.0:0.01-1.0:0.5-3.0;
wherein the complex metal oxide composite is a complex of two or three metal oxides selected from the group consisting of ferric oxide, cobalt oxide, and nickel oxide, the lanthanum doping composite comprises lanthanum oxide, and the enhanced catalytic composite comprises molybdenum oxide.

2. The catalyst as claimed in claim 1, wherein a molar ratio of iron and cobalt is 0.1-1.0:0.1-1.0 in the complex of two metal oxides comprising ferric oxide and cobalt oxide; a molar ratio of cobalt and nickel is 0.1-1.0:0.1-1.0 in the complex of two metal oxides comprising cobalt oxide and nickel oxide; a molar ratio of iron and nickel is 0.1-1.0:0.1-1.0 in the complex of two metal oxides comprising ferric oxide and nickel oxide; and a molar ratio of iron, cobalt, and nickel is 0.1-1.0:0.1-1.0:0.1-1.0 in the complex of three metal oxides comprising ferric oxide, cobalt oxide and nickel oxide.

3. A method for producing a lanthanum doping catalyst for preparing carbon nanotubes having uniform diameter, comprising the steps of:
(1) dissolving magnesium salt into distilled water with stirring to be a solution;
(2) adding metal salt for forming complex metal oxide composite, lanthanum salt for forming lanthanum doping composite and salt for forming enhanced catalytic composite into the solution with continuous stirring to dissolve completely, and a molar ratio of magnesium salt, metal salts for forming complex metal oxide composite, lanthanum salt for forming lanthanum doping composite and salt for forming enhanced catalytic composite being 0.5-2.5:0.1-1.0:0.1-1.0:0.5-3.0;
(3) drying the solution from step (2) at 120-200° C. for 3-5 hours;
(4) calcinating at high temperature of 550-850° C. for 10-30 minutes under aerobic environment; and
(5) obtaining the catalyst for preparing carbon nanotubes after grinding the product got from step (4) to be a fine powder.

4. The method as claimed in claim 3, wherein the magnesium salt is selected from the group consisting of magnesium nitrate, magnesium chloride, magnesium sulfate, and magnesium acetate, or a mixture of two, three, or four of the magnesium salts.

5. The method as claimed in claim 3, wherein the metal salt for forming the complex metal oxide composite comprises two or three metal salts selected from the group consisting of iron salt, cobalt salt and nickel salt.

6. The method as claimed in claim 5, wherein the iron salt is selected from a group consisting of ferric nitrate, ferric chloride, ferric sulfate, ferric acetate; the cobalt salt is selected from a group consisting of cobalt nitrate, cobalt chloride, cobalt sulfate, cobalt acetate; and the nickel salt is selected from a group consisting of nickel nitrate, nickel chloride, nickel sulfate, nickel acetate.

7. The method as claimed in claim 3, wherein the lanthanum salt for forming lanthanum doping composite is selected from the group consisting of lanthanum nitrate, lanthanum carbonate, and lanthanum acetate; and the salt for forming enhanced catalytic composite is molybdate.

8. The method as claimed in claim 6, wherein a molar ratio of iron:cobalt is 0.1-1.0:0.1-1.0 in the complex composite comprising iron salt and cobalt salt; a molar ratio of cobalt:nickel is 0.1-1.0:0.1-1.0 in the complex composite comprising cobalt salt and nickel salt; a molar ratio of iron:nickel is 0.1-1.0:0.1-1.0 in the complex composite comprising iron salt and nickel salt; and a molar ratio of iron:cobalt:nickel is 0.1-1.0:0.1-1.0:0.1-1.0 in the complex composite comprising iron salt, cobalt salt and nickel salt.
